(19) United States
(12) Patent Application Publication
(10) Pub. No.: US 2009/0058258 A1
(43) Pub. Date: Mar. 5, 2009

(54) LIGHT EMISSION DEVICE AND DISPLAY DEVICE USING THE LIGHT EMISSION DEVICE AS ITS LIGHT SOURCE

(76) Inventors: Cheol-Hyeon Chang, Suwon-si (KR); Byong-Gon Lee, Suwon-si (KR); Il-Hwan Kim, Suwon-si (KR)

Correspondence Address: CHRISTIE, PARKER & HALE, LLP, PO BOX 7068, PASADENA, CA, 91109-7068, US

(21) Appl. No.: 12/203,748

(22) Filed: Sep. 3, 2008

(30) Foreign Application Priority Data
Sep. 3, 2007 (KR) 10-2007-0089017

(51) Int. Cl. H01J 1/62

(52) U.S. Cl. 313/497

(57) ABSTRACT

A light emission device including first and second substrates facing each other, electron emission elements on the first substrate, an anode electrode with a phosphor layer on the second substrate, and spacers between the first and second substrates. Each spacer includes a spacer body comprising a dielectric material, a first coating layer on a first region of the spacer body, the first region being adjacent to the first substrate, and a second coating layer on a second region of the spacer body, the second region being adjacent to the second substrate, wherein a maximum secondary electron emission coefficient of the first coating layer under an operation voltage condition applied to the first region is about 0.8 to about 1 and a maximum secondary electron emission coefficient of the second coating layer under an operation voltage condition applied to the first and second regions is about 3 to about 16.

### CROSSED-REFERENCE TO RELATED APPLICATION

This application makes claims priority to and the benefit of Korean Patent Application No. 10-2007-0089017, filed on Sep. 3, 2007, in the Korean Intellectual Property Office, the entire content of which is incorporated herein by reference.

### BACKGROUND OF THE INVENTION

1. Field of the Invention

The present invention relates to a light emission device and a display device using the light emission device as its light source.

2. Description of Related Art

There are many different types of light emission devices that radiate visible light. One type of light emission device includes an electron emission unit composed of electron emission regions and driving electrodes that are disposed on a first substrate and a light emission unit composed of a phosphor layer and an anode electrode that are disposed on a second substrate. This type of light emission device may be used as a light source in a display device having a non-self emissive display panel.

In addition, electron emission elements include the electron emission regions and the driving electrodes, and there are several types of cold cathode electron emission elements, including field emission array (FEA) type electron emission elements and surface-conduction emission (SCE) type electron emission elements.

Moreover, the electron emission unit includes the plurality of driving electrodes functioning as scan electrodes and data electrodes for controlling an amount of electron emission from each pixel. The light emission unit accelerates electrons emitted from the first substrate toward the second substrate by applying a high voltage (anode voltage) to the anode electrode. The electrons excite the phosphor layer to emit visible light, thereby emitting light and displaying an image.

In the electron emission device (or display) as discussed above, the first and second substrates are sealed together at their peripheries using a sealing member such as frit bars to form a vacuum vessel. The interior of the vacuum vessel is exhausted to be kept at a degree of vacuum of about 10⁻⁶ Torr. Due to a pressure difference between the interior and the exterior of the vacuum vessel, a high compression force is applied onto the vacuum vessel. The compression force increases in proportion to the screen size of the electron emission device.

Therefore, a plurality of spacers are disposed in the vacuum vessel to endure the compression force applied to the vacuum vessel and to uniformly maintain a gap between the first and second substrates. At this point, the spacers are mainly formed of a dielectric material such as glass or ceramic to prevent (or protect from) a short circuit between the driving electrodes provided on the first substrate and the anode electrode provided on the second substrate.

However, in the conventional electron emission display, the electrons emitted from the electron emission region travel toward the second substrate with a divergence (e.g., at a predetermined divergence angle) instead of traveling in a straight line. Due to the divergence of the electron beam, the electrons collide with surfaces of the spacers and thus the spacers are charged with a positive or negative potential depending on material properties thereof (e.g., dielectric constant or secondary electron emission coefficient).

The charged spacers alter the electric fields therearound, thereby distorting the electron beam paths. For example, the spacers charged with the positive potential attract ambient electrons and the spacers charged with the negative potential repel ambient electrons. Here, the distortion of the electron beam paths obstructs the accurate color expressions around the spacers, and may cause areas where the spacers are to be viewable on the screen, thereby deteriorating the display quality.

### SUMMARY OF THE INVENTION

An aspect of an embodiment of the present invention is directed toward a light emission device having spacers installed in a vacuum vessel of the light emission device to endure a compression force applied to the vacuum vessel.

An aspect of an embodiment of the present invention is directed toward an electron emission display that suppresses electron beam distortion around its spacers by causing surfaces of the spacers to be charged with a neutral potential to thereby improve its display quality.

According to an embodiment of the present invention, a light emission device includes a first substrate and a second substrate facing each other with a gap therebetween, an electron emission unit on the first substrate and including a plurality of electron emission elements, a light emission unit on the second substrate and including a phosphor layer and an anode electrode, and a plurality of spacers between the first and second substrates. Here, each of the spacers includes a spacer body composed of a dielectric material, a first coating layer on a side surface of a first region of the spacer body, the first region being adjacent to the first substrate, and a second coating layer on a side surface of a second region of the spacer body, the second region being adjacent to the second substrate. A maximum secondary electron emission coefficient of the first coating layer under an operation voltage condition applied to the first region is about 0.8 to about 1, and a maximum secondary electron emission coefficient of the second coating layer under an operation voltage condition applied to the first and second regions is about 3 to about 16.

In one embodiment, the spacer body includes a third region, a fourth region, and a reference position between the third and fourth regions. Here, a secondary electron emission coefficient of the third region under an operation voltage condition applied to the light emission device is higher than 1, a secondary electron emission coefficient of the reference position under the operation voltage condition applied to the light emission device is 1, and a secondary electron emission coefficient of the fourth region under the operation voltage condition applied to the light emission device is less than 1.

The first and second regions of the spacer body may be separated from each other by the reference position.

The first region may be identical to the third region, and the second region may be identical to the fourth region.

A secondary electron emission coefficient of the second coating layer under an operation voltage condition applied to the second region may be greater than 1.

The first coating layer may include a material selected from the group consisting of graphite, diamond-like carbon, carbon nanotubes, Cr₂O₃, AlN, and combinations thereof.

The second coating layer may include a material selected from the group consisting of MgO, BeO, BaO, Al₂O₃, and combinations thereof.

The first coating layer and the second coating layer may contact each other such that a side surface of the spacer body is entirely covered and not exposed.

The electron emission element may include a cathode electrode extending in a first direction, a gate electrode insulated from the cathode electrode and extending in a second direction crossing the first direction, and an electron emission region electrically connected to the cathode electrode.

The electron emission unit may include a focusing electrode on the cathode electrode and the gate electrode.

The electron emission element may include a first electrode extending in a first direction, a second electrode insulated from the first electrode and extending in a second direction crossing the first direction, a first conductive layer electrically connected to the first electrode, a second conductive layer electrically connected to the second electrode, and an electron emission region between the first conductive layer and the second conductive layer.

According to an embodiment of the present invention, a display device includes a display panel for displaying an image, and a light emission device for providing light to the display panel. The light emission device includes a first substrate and a second substrate facing each other with a gap therebetween, an electron emission unit on the first substrate and including a plurality of electron emission elements, a light emission unit on the second substrate and including a phosphor layer and an anode electrode, and a plurality of spacers between the first and second substrates. Here, each of the spacers includes a spacer body composed of a dielectric material, a first coating layer on a side surface of a first region of the spacer body, the first region being adjacent to the first substrate, and a second coating layer on a side surface of a second region of the spacer body, the second region being adjacent to the second substrate. A maximum secondary electron emission coefficient of the first coating layer under an operation voltage condition applied to the first region is about 0.8 to about 1, and a maximum secondary electron emission coefficient of the second coating layer under an operation voltage condition applied to the first and second regions is about 3 to about 16.

In one embodiment, the display panel includes a plurality of first pixels, the light emission device includes a plurality of second pixels, the plurality of second pixels being fewer in number than the plurality of first pixels, and wherein each of the plurality of second pixels is configured to emit light to correspond to a highest gray level among gray levels of its corresponding first pixels of the plurality of first pixels. The display panel may be a liquid crystal display panel.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partial sectional view of a light emission device according to a first embodiment of the present invention;

FIG. 2 is an exploded perspective view of an active area of the light emission device of FIG. 1;

FIG. 3 is a graph illustrating a secondary electron emission coefficient property of a spacer body of a spacer with respect to incident energy;

FIG. 4 is a schematic sectional view illustrating first and second substrates and a body of a spacer;

FIG. 5 is a graph illustrating a secondary electron emission coefficient property of a first coating layer and a second coating layer with respect to incident energy;

FIG. 6 is a graph illustrating a secondary electron emission coefficient property of a first coating layer and a second coating layer of a spacer with respect to a spacer body;

FIG. 7 is an exploded perspective view of a display device using a light source composed of the light emission device according to FIG. 1;

FIG. 8 is a sectional view of a display panel shown in FIG. 7;

FIG. 9 is an exploded partial perspective view of a light emission device according to a second embodiment of the present invention;

FIG. 10 is a partial sectional view of a light emission device according to a third embodiment of the present invention; and

FIG. 11 is a partial top plan view of an electron emission unit shown in FIG. 10.

### DETAILED DESCRIPTION OF THE EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

In embodiments of the present invention, a light emission device refers to all devices for radiating visible light. Accordingly, light emission devices as used herein include display devices for transmitting information by displaying symbols, letters, numbers, and images. In addition, the light emission device may be used as a light source for providing light to a non-self emissive display panel.

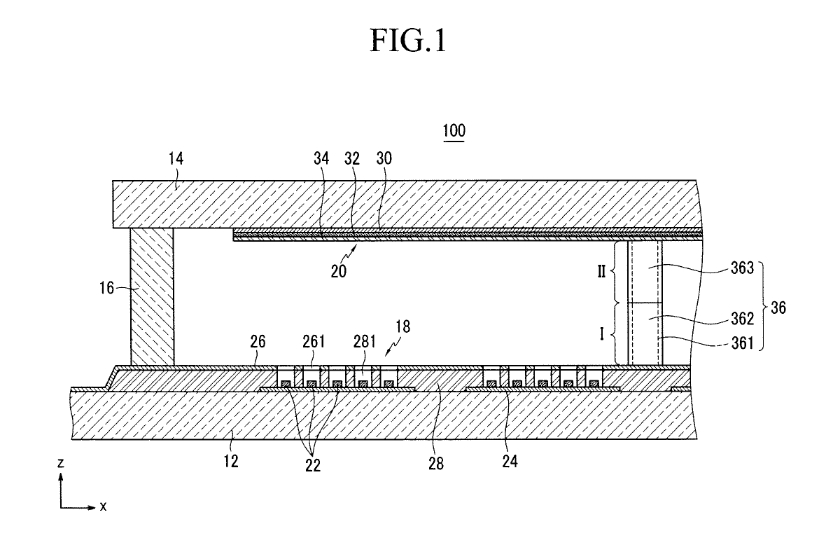

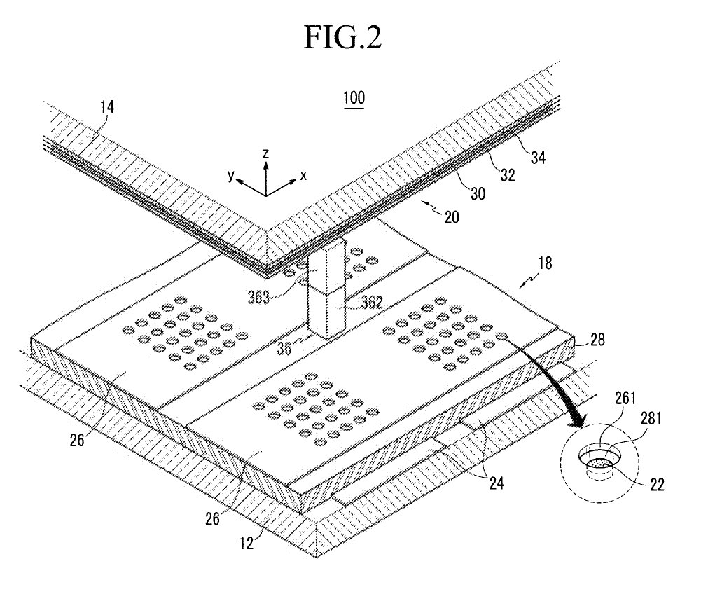

FIG. 1 is a partial sectional view of a light emission device according to a first embodiment of the present invention, and FIG. 2 is an exploded perspective view of an active area of the light emission device of FIG. 1.

Referring to FIGS. 1 and 2, a light emission device 100 includes first and second substrates 12 and 14 facing each other in parallel with a distance therebetween that may be predetermined. The first and second substrates 12 and 14 are sealed together at their peripheries using a sealing member 16 to provide a vacuum vessel. The interior of the vacuum vessel is exhausted to a degree of vacuum of about 10⁻⁶ Torr.

Each of the first and second substrates 12 and 14 has an active area for emitting visible light and a non-active area surrounding the active area. An electron emission unit 18 for emitting electrons is provided on the first substrate 12 at the active area, and a light emission unit 20 for emitting visible light is provided on the second substrate 14 at the active area.

The second substrate 14 with the light emission unit 20 disposed thereon may be a front substrate of the light emission device 100, and the first substrate 12 with the electron emission unit 18 disposed thereon may be a rear substrate of the light emission device 100.

The electron emission unit 18 includes an electron emission region 22 and driving electrodes 24 and 26. That is, the driving electrodes include a plurality of cathode electrodes 24 arranged on the first substrate 12 in a stripe pattern (or arranged in stripes) extending in a first direction (e.g., y direction of FIG. 2), and a plurality of gate electrodes 26 arranged on an insulating layer 28 in a stripe pattern (or arranged in stripes) extending in a second direction (x direction of FIG. 2) crossing the first direction.

Openings 261 and 281 corresponding to the respective electron emission regions 22 are formed in the insulating layer 28 and the gate electrodes 26 at each crossing region of the cathode and gate electrodes 24 and 26 to partly expose the surface of the cathode electrodes 24. The electron emission regions 22 are arranged on the exposed portions of the cathode electrodes 24 through the openings 281 of the insulating layer 28.

The electron emission regions 22 are formed of a material that emits electrons when an electric field is applied thereto under a vacuum atmosphere, such as a carbon-based material or a nanometer-sized material. The electron emission regions 22 can be formed of carbon nanotubes, graphite, graphite nanofibers, diamonds, diamond-like carbon, C₆₀, silicon nanowires, or combinations thereof. Alternatively, the electron emission regions can be formed into a tip structure formed of a Mo-based and/or Si-based material.

One crossing region of the cathode and gate electrodes 24 and 26 may correspond to one pixel region of the light emission device 100. Here, the electron emission regions 22 in one crossing region may form an electron emission element. Alternatively, two or more crossing regions of the cathode and gate electrodes 24 and 26 may correspond to one pixel region of the light emission device 100.

The light emission unit 20 includes an anode electrode 30, a phosphor layer 32 disposed on the anode electrode, and a reflective layer 34 covering the phosphor layer 32.

The anode electrode 30 is made of a transparent conductive material such as indium tin oxide (ITO) for transmitting visible light emitted from the phosphor layer 32. The anode electrode 30 is an acceleration electrode that attracts the electron beam. The anode electrode 30 receives more than several thousand volts of DC voltage (anode voltage), and sustains the phosphor layer 32 at a high potential state.

The phosphor layer 32 may be a phosphor mixture that emits white light. The phosphor mixture is a mixture of red phosphor, green phosphor, and blue phosphor, and it may be formed on the entire light emitting region of the second substrate 14 or distributed at each of the pixel regions. In FIG. 1 and FIG. 2, the phosphor layer 32 is shown to be formed on the entire light emitting region of the second substrate 14.

The reflective layer 34 may be an aluminum layer having a thickness of several thousand Å, and include fine holes for passing an electron beam therethrough. The reflective layer 34 reflects visible light, which is emitted toward the first substrate 12 from the phosphor layer 32, back toward the second substrate 14. Therefore, luminance of the light emission device 100 is improved. Also, in one embodiment, the anode electrode 30 may be omitted, and the reflective layer 34 may operate as the anode electrode 30 by receiving the anode voltage.

Spacers 36 are disposed between the first and second substrates 12 and 14 for enduring a compression force applied to the vacuum vessel and uniformly maintaining a gap between the first and second substrates 12 and 14. The spacers 36 have a height (that may be predetermined) in a thickness (or z) direction of the first and second substrates 12 and 14.

The light emission device 100 is driven by applying a scan driving voltage to either the cathode electrodes 24 or the gate electrodes 26, applying a data driving voltage to the other electrodes, and applying an anode voltage that is higher than about several thousand volts to the anode electrode 30.

Thereby, electric fields are formed around the electron emission regions 22 in pixels where a voltage difference between the cathode electrode 24 and the gate electrode 26 is greater than a threshold value, and electrons are emitted therefrom. The emitted electrons are pulled by the anode voltage applied to the anode electrode 30 to collide with the corresponding phosphor layer 32, thereby causing light emission. Luminance of the phosphor layer 32 for each pixel corresponds to the amount of electrons emitted for the corresponding pixel.

In this process, the light emission unit 20 and the electron emission unit 18 have a voltage difference of several to tens of kilovolts in accordance with the value of the anode voltage. Consequently, a voltage gradient is generated at the vacuum region between the first and the second substrates 12 and 14, in which the voltage increases gradually from the electron emission unit 18 toward the light emission unit 20. Furthermore, during the above-described driving process, the electrons emitted from the electron emission regions 22 are diffused toward the second substrate 14, and thus some of the electrons collide with the surfaces of the spacers 36.

Each spacer 36 of an embodiment of the present invention is designed with the following structure so that the surface thereof can be electrically neutral under the driving environment of the above-described light emission device 100, thereby minimizing or reducing electron beam distortion caused by a charge of the spacer 36.

In one embodiment, the spacer 36 includes a spacer body 361 formed of a dielectric, and a first coating layer 362 positioned on a side surface of a lower region (or a first region I) of the spacer body 361, and a second coating layer 363 positioned on a side surface of an upper region (or a second region II) of the spacer body 361.

The spacer body 361 is formed of a dielectric such as glass, ceramic, reinforced glass, or a glass-ceramic mixture in the shape of a bar, a pillar, or various other suitable shapes. For example, FIG. 2 shows that the spacer body 36 has a shape of a rectangular pillar.

The first coating layer 362 has a maximum secondary electron emission coefficient of 0.8 to 1 under an operation voltage condition applied to the first region of the spacer 36. The second coating layer 363 has a maximum secondary electron emission coefficient of 3 to 16 under the operation voltage condition applied to the first and second regions of the spacer 36.

The first and second coating layers 362 and 363 may be formed of bulk materials having different dopants. For example, the first coating layer 362 may include a material selected from the group consisting of graphite, diamond-like carbon, carbon nanotubes, Cr₂O₃, AlN, and combinations thereof. The second coating layer 363 may include a material selected from the group consisting of MgO, BeO, BaO, Al₂O₃, and combinations thereof.

An upper end of the first coating layer 362 contacts a lower end of the second coating layer 363 so that the side surface of the spacer body 361 is covered by the coating layers 362 and 263 and is not exposed to the vacuum region. The first and second coating layers 362 and 363 function to reduce the positive or negative potential, which may be charged on the surface of the spacer body 361 during the above-described driving process, by interacting with the positive or negative potential using their respective secondary electron emission coefficient properties.

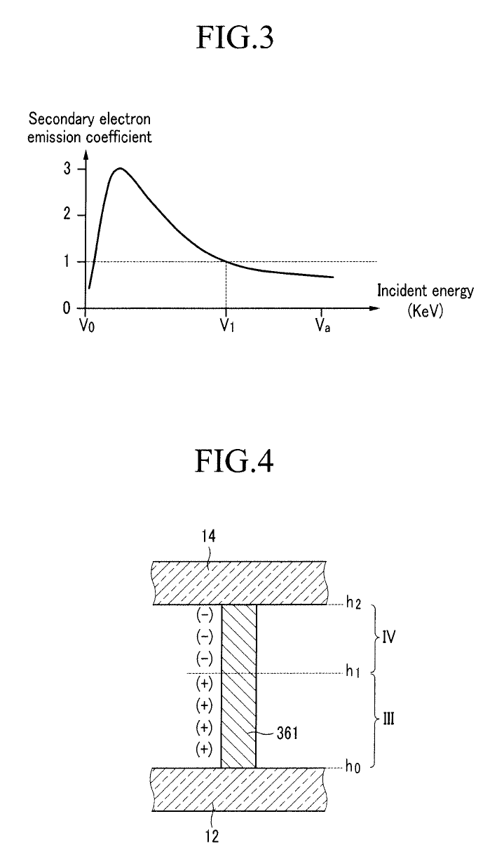

FIG. 3 is a graph illustrating a secondary electron emission coefficient property of the spacer body of the spacer with respect to incident energy, and FIG. 4 is a schematic sectional view illustrating the first and second substrates and the spacer body of the spacer.

In the graph of FIG. 3, the horizontal axis labeled as “incident energy” indicates a voltage gradient of a vacuum region in a height direction of the spacer 36. V0 indicates 0V, and Va indicates an anode voltage applied to the anode electrode 30.

In FIG. 4, h₀ indicates the lower end of the spacer body 361, which faces the first substrate 12, h₁ indicates a boundary between the upper and lower regions (or third and fourth regions, III and IV) of the spacer body 361, and h₂ indicates the upper end of the spacer body 361, which faces the second substrate 14.

Referring to FIGS. 3 and 4, the spacer body 22 formed of the conventional dielectric is divided depending on intensity of the incident energy into the third region III where the secondary electron emission coefficient is higher than 1 and the fourth region IV where the secondary electron emission coefficient is less than 1. Here, the secondary electron emission coefficient of the spacer body 361 is 1, when a voltage of V₁ is applied, and the h₁ (a reference position) is set at a location where the voltage V₁ is located in the height direction of the spacer body 361.

When the secondary electron emission coefficient is greater than 1, the surface is charged with the positive potential. When the secondary electron emission coefficient is less than 1, the surface is charged with the negative potential. Therefore, the third region III defined between the h₀ and h₁, where the secondary electron emission coefficient is greater than 1, i.e., the lower region of the spacer body 361, is surface-charged with the positive potential. In addition, the fourth region IV defined between the h₁ and h₂, where the secondary electron emission coefficient is less than 1, i.e., the upper region of the spacer body 361, is surface-charged with the negative potential.

When the light emission device 100 is driven, the amount of discharges generated by collision of an electron beam in the lower region of the spacer body is small, but the amount of discharges generated in the upper region is larger than the lower region. This is because the number of electrons that collide with the upper region is higher than that of the lower region. Thus, it is important to suppress the electric charge in the upper region.

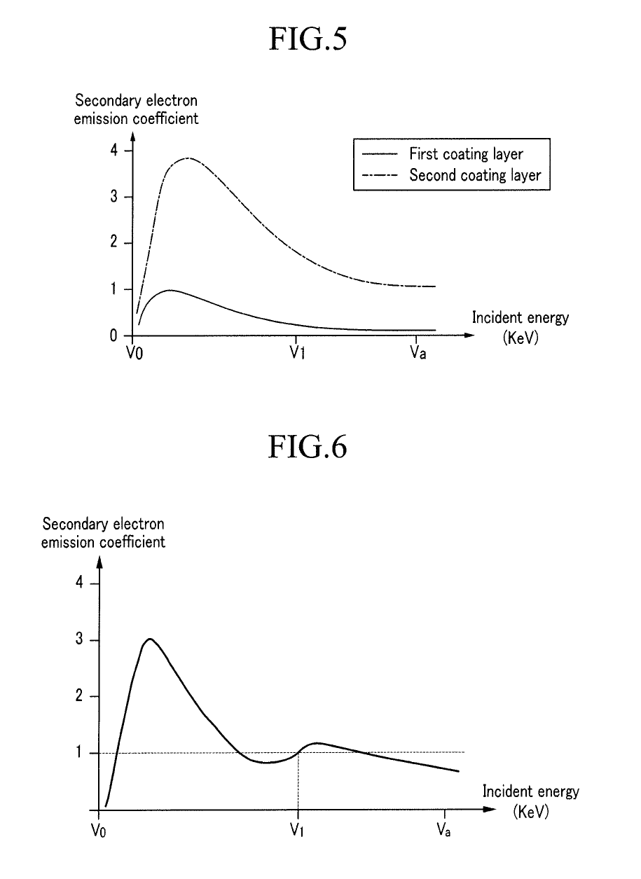

FIG. 5 is a graph illustrating the secondary electron emission coefficient property of the first and second coating layers of the spacer with respect to incident energy. In the graph of FIG. 5, a horizontal axis labeled as “incident energy” indicates a voltage gradient in a vacuum region in a height direction of the spacer.

Referring to FIG. 5, the first and second coating layers 362 and 363 each have a secondary electron emission coefficient property that is slowly reduced after steeply increasing as the intensity of the incident energy increases. The first coating layer 362 has a secondary electron emission coefficient of less than 1 at substantially all the overall range of the incident energy. The second coating layer 363 has a secondary electron emission coefficient of greater than 1 at substantially all the overall range of the incident energy.

In more detail, a maximum secondary electron emission coefficient of the first coating layer 362 under a voltage condition (or operation voltage condition) of V₀ to V₁ is 1 or less, and the first coating layer 362 generates a negative electric charge and offsets a positive electric charge formed at the lower region therewith. The second coating layer 363 has a maximum secondary electron emission coefficient of 3 or more under a voltage condition (or operation voltage condition) of V₀ to Vₐ, and has a secondary electron emission coefficient that is greater than 1 under a voltage condition (or operation voltage condition) of V1 to Va. Thus, the second coating layer 363 can generate a positive electric charge and offset a negative electric charge formed at the upper region of the spacer body 361.

Here, in one embodiment, when the maximum secondary electron emission coefficient of the first coating layer 362 is greater than 1, it is difficult to provide a suitable effect for preventing (or protecting from) an electric discharge. In another embodiment, when the maximum secondary electron emission coefficient is less than 3, since the secondary electron emission coefficient of the second coating layer 363 would be less than 1, the prevention (or protection) of the electric discharge by the second coating layer 363 cannot be accomplished. That is, when the maximum secondary electron emission coefficient becomes large, the overall secondary electron emission coefficient of the second coating layer 363 under a voltage condition of V₁ to Vₐ is also large, and the efficiency of preventing or reducing the electric discharge by the second coating layer 363 is also increased.

Regarding selection of a material of the first coating layer 362, a maximum secondary electron emission coefficient of a material should be more than 0.8, but less than 1 under a voltage condition of V₀ to V₁. Also, regarding selection of a material of the second coating layer 363, a maximum secondary electron emission coefficient of a material should be more than 3, but less than 16 under a voltage condition of V₀ to Vₐ. Thus, the first coating layer 362 has a maximum secondary electron emission coefficient of 0.8 to 1 under the voltage condition of V₀ to V₁, and the second coating layer 363 has a maximum secondary electron emission coefficient of 3 to 16 under the voltage condition of V₀ to Vₐ.

FIG. 6 is a graph illustrating the secondary electron emission coefficient property of the first and second coating layers of the spacer body.

Referring to FIG. 6, under an operating voltage of the light emission device 100 and as a result of the first and second coating layers on the spacer 36, a relative secondary electron emission coefficient of the first and second coating layers 362 and 363 for the spacer body 361 (except for a part of the lower portion of the spacer 36 according to the height direction (z direction of FIGS. 1 and 2)) approaches 1.

That is, a relative secondary electron emission coefficient of the first coating layer 362 of the spacer body 361 for an upper part of the lower portion of the spacer 36 representing the voltage condition of V₀ to V₁ approaches 1, and a relative secondary emission coefficient of the second coating layer 363 of the spacer body 361 at the entire upper portion of the spacer 36 representing the voltage condition of V₀ to Vₐ approaches 1.

Accordingly, the surface of the spacer 36 of an embodiment of the present invention becomes electrically neutral due to the first and second coating layers 362 and 363 at the upper part of the lower portion of the spacer 36 and at the entire upper portion of the spacer 36, so no electron beam distortion around the spacer 36 is induced. As a result, the light emission device 100 of the embodiment of the present invention can improve uniformity of brightness around the spacer 36 and reduce the likelihood that the spacer 36 can be viewed on the screen.

The above light emission device 100 may be used as a light source for providing white light to a non-emissive type panel display. The first substrate 12 and the second substrate 14 in the light emission device 100 may have a distance of 5 to 12 mm therebetween, and thereby decreases an arc discharge in the vacuum vessel. Furthermore, a high voltage of more than 10 kV (e.g., a voltage of 10 to 15 kV) can be applied to the anode electrode 30.

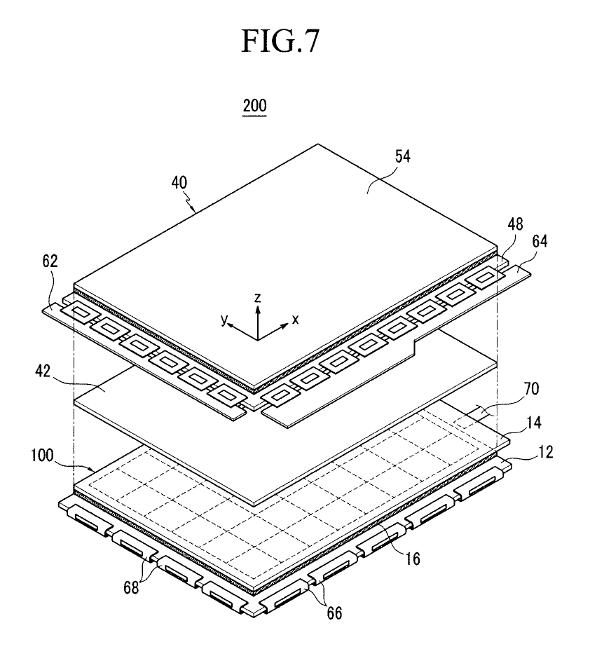

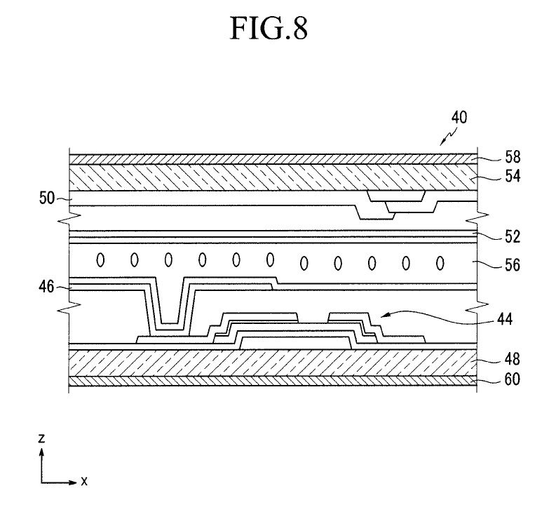

FIG. 7 is an exploded perspective view of a display device using a light source composed of the light emission device according to FIG. 1, and FIG. 8 is a sectional view of a display panel shown in FIG. 7.

As shown in FIG. 7, a display device 200 according to an embodiment of the present invention includes the light emission device 100, and a display panel 40 provided in front of the light emission device 100. A light diffuser 42 for evenly diffusing light emitted from the light emission device 100 may be provided between the light emission device 100 and the display panel 40, and the light diffuser 42 and the light emission device 100 may be spaced apart from each other.

The display panel 40 may be a liquid crystal display panel or another suitable non-self emissive (or passive) display panel. A liquid crystal display panel will be described in more detail below.

As shown in FIG. 8, the display panel 40 includes a lower substrate 48 on which thin film transistors (TFTs) 44 and pixel electrodes 46 are formed, an upper substrate 54 on which a color filter layer 50 and a common electrode 52 are formed, and a liquid crystal layer 56 provided between the upper substrate 54 and the lower substrate 48. Polarizing plates 58 and 60 are provided on an upper surface of the upper substrate 54 and a lower surface of the lower substrate 48, respectively, to polarize the light transmitted through the display panel 40.

A pixel electrode 46 is positioned in each sub-pixel, and is controlled by the TFT 44. The pixel electrodes 46 and the common electrode 52 are formed of transparent materials. The color filter layer 50 includes a red filter layer, a green filter layer, and/or a blue filter layer for each sub-pixel.

When the TFT 44 of a sub-pixel is turned on, an electric field is formed between the pixel electrode 46 and the common electrode 52, and the arrangement angles of liquid crystal particles change according to the electric field. Therefore, light transmittance varies with the changed in the arrangement angles. As such, the display panel 40 can control the luminance and emit color for each pixel through the process as described above.

In addition, FIG. 7 also shows a gate circuit board assembly 62 for transmitting a gate driving signal to a gate electrode of each TFT 44, and a data circuit board assembly 64 for transmitting a data driving signal to the source electrode of each TFT 44.

Referring to FIG. 7, the light emission device 100 includes fewer pixels than the display panel 40 so that a single pixel of the light emission device 100 corresponds to two or more pixels of the display panel 40. Each pixel of the light emission device 100 can emit light corresponding to the highest gray level among a plurality of pixels of the display panel 40, and can display gray levels in gray scale of 2 to 8.

For purposes of convenience of description, a pixel of the display panel 40 is referred to as a first pixel, and a pixel of the light emission device 100 is referred to as a second pixel. A plurality of first pixels corresponding to one second pixel are referred to as a first pixel group.

A method for driving the light emission device 100 may include \textcircled{1} detecting the highest gray level among the first pixels of the first pixel group at a signal controller for controlling the display panel 40, \textcircled{2} calculating a gray level of the light to be emitted by the second pixel according to the detected gray level and converting the calculated gray level to digital data, \textcircled{3} generating a driving signal of the light emission device 100 using the digital data, and \textcircled{4} applying the generated driving signal to the driving electrode of the light emission device 100.

The driving signal of the light emission device 100 includes a scan driving signal and a data driving signal. The cathode electrodes or the gate electrodes receive the scan driving signal, and the others electrodes receive the data driving signal.

A scan circuit board assembly and a data circuit board assembly may be disposed at a rear surface of the light emission device 100 for driving the light emission device 100. In FIG. 7, a first connector 66 is for connecting the cathode electrodes and the data circuit board assembly, and a second connector 68 is for connecting the gate electrodes and a scan circuit board assembly. The anode electrode is connected to a third connector 70 so as to receive the anode voltage through the third connector 70.

The second pixel of the light emission device 100 is synchronized with the first pixel group and emits light at a gray level when an image is displayed on the corresponding first pixel group. That is, the light emission device 100 provides light with high luminance to a bright area of the display panel 40 and provides light with low luminance to a dark area of the display panel 40. Accordingly, the display device 200 according to an embodiment of the present invention can increase the contrast ratio of the screen and provide sharp image quality.

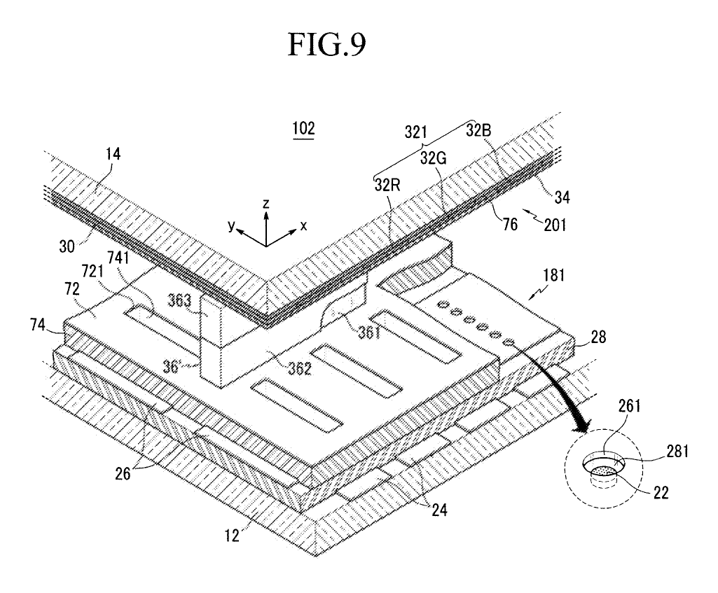

FIG. 9 is an exploded partial perspective view of a light emission device according to a second embodiment of the present invention. Like reference numerals are used for like elements that have been described above.

As shown in FIG. 9, a light emission device 102 includes an electron emission unit 181 that further includes a focusing electrode 72 positioned on the gate electrodes 26. When the insulating layer 28 positioned between the cathode electrode 24 and the gate electrode 26 is referred to as a first insulation layer, a second insulation layer 74 is provided between the gate electrodes 26 and the focusing electrode 72.

The second insulation layer 74 and the focusing electrode 72 include openings 741 and 721 through which the electron beam is transmitted. The focusing electrode 72 receives a ground voltage or several to tens of negative DC volts to focus electrons transmitted through the focusing electrode opening 721.

The size of a crossing region of the cathode electrode 24 and the gate electrode 26 may be smaller than the size of the crossing region of the embodiment shown in FIGS. 1 and 2, and the number of electron emission regions 22 positioned on each crossing region of the present embodiment may be less than the number of electron emission regions 22 positioned on each crossing region of the embodiment shown in FIGS. 1 and 2.

A light emission unit 201 includes a red phosphor layer 32R, a green phosphor layer 32G, and a blue phosphor layer 32B spaced apart from each other, and a black layer 76 provided between respective phosphor layers 321.

The crossing region of the cathode electrode 24 and the gate electrode 26 may correspond to one sub-pixel, and a respective one of the red, green, or blue phosphor layer 32R, 32G, and 32B is positioned to correspond to one sub-pixel. Three sub-pixels in which the red phosphor layer 32R, the green phosphor layer 32G, and the blue phosphor layer 32B are arranged form one pixel.

The amount of emitted electrons of the electron emission regions 22 for each sub-pixel is determined by a driving voltage applied to the cathode electrode 24 and the gate electrode 26, and the electrons collide with the phosphor layers 32R, 32G, and 32B of the corresponding sub-pixels to excite the phosphor layer 321. The light emission device 102 controls pixel luminance and light emission colors to realize a color screen.

In the light emission device 102 according to the present embodiment, a spacer 36′ includes the spacer body 361, the first coating layer 362, and the second coating layer 363 as in the first embodiment. When the light emission device 102 is operated, the spacer 36′ can minimize or reduce accumulation of an electric charge and thereby prevent or reduce a distortion of the electron beam path generated around the spacer 36′. As an example, the spacer 36′ is shown to have a shape of a bar.

While it has been illustrated above that the electron emission unit is a field emission array (FEA) type, it may also be formed as a surface-conduction emission (SCE) type.

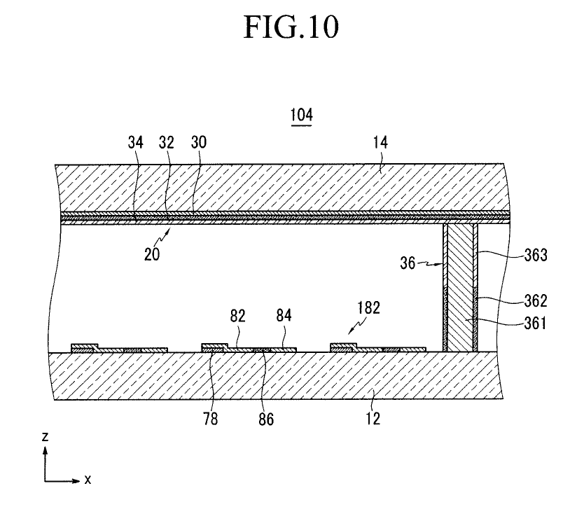

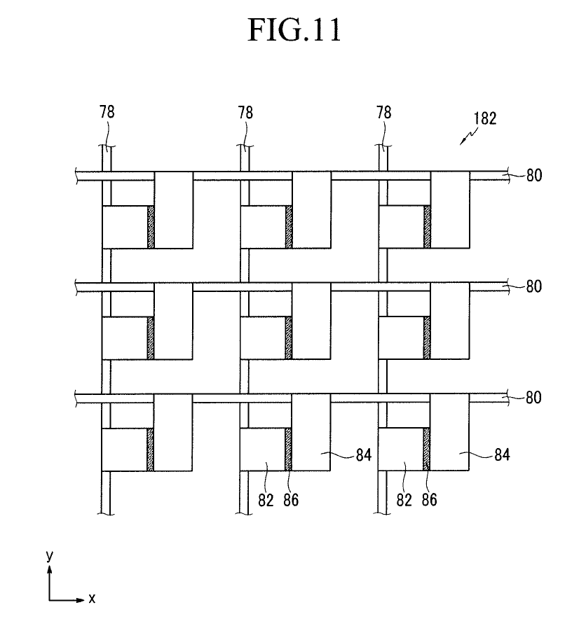

FIG. 10 is a partial sectional view of a light emission device according to a third embodiment of the present invention, and FIG. 11 is a partial top plan view of an electron emission unit shown in FIG. 10.

As shown in FIG. 10 and FIG. 11, a light emission device 104 is substantially the same as the light emission devices according to the embodiments shown in FIGS. 1, 2, and 9, except that the electron emission unit 182 is an SCE type. As an example, FIG. 10 shows a light emission unit and a spacer that are substantially the same (or are the same types) as that of the embodiment shown in FIGS. 1 and 2, and uses like reference numerals for like elements.

The electron emission unit 182 includes first electrodes 78 formed in a stripe pattern (or stripes) extending along a first direction of the first substrate 12, second electrodes 80 formed in a stripe pattern (or stripes) extending along a second direction crossing the first direction, and insulated from the first electrodes 78, first conductive layers 82 electrically connected to the first electrodes 78, second conductive layers 84 electrically connected to the second electrodes 80 and spaced apart from the first conductive layers 82, and electron emission regions 86 provided between the first conductive layers 82 and the second conductive layers 84.

Each electron emission region 86 includes a layer having a carbon-based material. In this case, the electron emission regions 86 may be composed of a material selected from the group consisting of carbon nanotubes, graphite, graphite nanofibers, diamond-like carbon, fullerene (C₆₀), and combinations thereof. In addition, the electron emission regions 86 may be formed as a small crevice or crack between the first conductive layer 82 and the second conductive layer 86.

In the above configuration, one first electrode 78, one second electrode 80, one first conductive layer 82, one second conductive layer 84, and one electron emission region 86 form one electron emission element. One electron emission element may correspond to one pixel area of the light emission device 104, or a plurality of electron emission elements may correspond to one pixel area of the light emission device 104.

When a driving voltage is applied to the first electrode 78 and the second electrode 80, an electric current flows through the first conductive layer 82 and the second conductive layer 84 in a direction substantially horizontal (or parallel) to a surface of the electron emission region 86, and surface-conduction emission is performed from the electron emission region 86.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emission device comprising:
a first substrate and a second substrate facing each other with a gap therebetween;
an electron emission unit on the first substrate and comprising a plurality of electron emission elements;
a light emission unit on the second substrate and comprising a phosphor layer and an anode electrode; and
a plurality of spacers between the first and second substrates,
wherein each of the spacers comprises:
a spacer body composed of a dielectric material;
a first coating layer on a side surface of a first region of the spacer body, the first region being adjacent to the first substrate; and
a second coating layer on a side surface of a second region of the spacer body, the second region being adjacent to the second substrate,
wherein a maximum secondary electron emission coefficient of the first coating layer under an operation voltage condition applied to the first region is about 0.8 to about 1, and
a maximum secondary electron emission coefficient of the second coating layer under an operation voltage condition applied to the first and second regions is about 3 to about 16.

2. The light emission device of claim 1, wherein the spacer body comprises a third region, a fourth region, and a reference position between the third and fourth regions, and
wherein a secondary electron emission coefficient of the third region under an operation voltage condition applied to the light emission device is higher than 1, a secondary electron emission coefficient of the reference position under the operation voltage condition applied to the light emission device is 1, and a secondary electron emission coefficient of the fourth region under the operation voltage condition applied to the light emission device is less than 1.

3. The light emission device of claim 2, wherein the first and second regions of the spacer body are separated from each other by the reference position.

4. The light emission device of claim 2, wherein the first region is identical to the third region and the second region is identical to the fourth region.

5. The light emission device of claim 4, wherein a secondary electron emission coefficient of the second coating layer under an operation voltage condition applied to the second region is greater than 1.

6. The light emission device of claim 1, wherein the first coating layer comprises a material selected from the group consisting of graphite, diamond-like carbon, carbon nanotubes, Cr₂O₃, AlN, and combinations thereof.

7. The light emission device of claim 1, wherein the second coating layer comprises a material selected from the group consisting of MgO, BeO, BaO, Al₂O₃, and combinations thereof.

8. The light emission device of claim 1, wherein the first coating layer and the second coating layer contact each other such that a side surface of the spacer body is entirely covered by the first and second coating layers.

9. The light emission device of claim 1, wherein the electron emission element comprises:
a cathode electrode extending in a first direction;
a gate electrode insulated from the cathode electrode and extending in a second direction crossing the first direction; and
an electron emission region electrically connected to the cathode electrode.

10. The light emission device of claim 9, wherein the electron emission unit further comprises a focusing electrode on the cathode electrode and the gate electrode.

11. The light emission device of claim 1, wherein the electron emission element comprises:
a first electrode extending in a first direction;
a second electrode insulated from the first electrode and extending in a second direction crossing the first direction;
a first conductive layer electrically connected to the first electrode;
a second conductive layer electrically connected to the second electrode; and
an electron emission region between the first conductive layer and the second conductive layer.

12. A display device comprising
a display panel for displaying an image; and
a light emission device for providing light to the display panel, the light emission device comprising:
a first substrate and a second substrate facing each other with a gap therebetween;
an electron emission unit on the first substrate and comprising a plurality of electron emission elements;
a light emission unit on the second substrate and comprising a phosphor layer and an anode electrode; and
a plurality of spacers between the first and second substrates,
wherein each of the spacers comprises:
a spacer body composed of a dielectric material;
a first coating layer on a side surface of a first region of the spacer body, the first region being adjacent to the first substrate; and
a second coating layer on a side surface of a second region of the spacer body, the second region being adjacent to the second substrate,
wherein a maximum secondary electron emission coefficient of the first coating layer under an operation voltage condition applied to the first region is about 0.8 to about 1, and
a maximum secondary electron emission coefficient of the second coating layer under an operation voltage condition applied to the first and second regions is about 3 to about 16.

13. The display device of claim 12, wherein the spacer body comprises a third region, a fourth region, and a reference position between the third and fourth regions, and
wherein a secondary electron emission coefficient of the third region under an operation voltage condition applied to the light emission device is higher than 1, a secondary electron emission coefficient of the reference position under the operation voltage condition applied to the light emission device is 1, and a secondary electron emission coefficient of the fourth region under the operation voltage condition applied to the light emission device is less than 1.

14. The display device of claim 13, wherein the first region is identical to the third region and the second region is identical to the fourth region.

15. The display device of claim 14, wherein a secondary electron emission coefficient of the second coating layer under an operation voltage condition applied to the second region is greater than 1.

16. The display device of claim 12, wherein the first coating layer comprises a material selected from the group consisting of graphite, diamond-like carbon, carbon nanotubes, Cr₂O₃, AlN, and combinations thereof.

17. The display device of claim 12, wherein the second coating layer comprises a material selected from the group consisting of MgO, BeO, BaO, Al₂O₃, and combinations thereof.

18. The display device of claim 12, wherein the display panel comprises a plurality of first pixels, wherein the light emission device comprises a plurality of second pixels, the plurality of second pixels being fewer in number than the plurality of first pixels, and wherein each of the plurality of second pixels is configured to emit light to correspond to a highest gray level among gray levels of its corresponding first pixels of the plurality of first pixels.

19. The display device of claim 12, wherein the display panel is a liquid crystal display panel.

20. A light emission device comprising:
a first substrate;
a second substrate facing the first substrate;
a plurality of electron emission elements on the first substrate;
an anode electrode with a phosphor layer on the second substrate; and
a plurality of spacers between the first and second substrates,
wherein each of the spacers comprises:
a dielectric spacer body;
a first coating layer on a side surface of a first region of the spacer body; and
a second coating layer on a side surface of a second region of the spacer body, the second region being between the first region and the second substrate,
wherein a maximum secondary electron emission coefficient of the first coating layer under an operation voltage condition applied to the first region is about 0.8 to about 1, and a maximum secondary electron emission coefficient of the second coating layer under an operation voltage condition applied to the first and second regions is about 3 to about 16.
